(19) United States
(12) Patent Application Publication
(10) Pub. No.: US 2007/0057523 A1
(43) Pub. Date: Mar. 15, 2007

(54) Plastic element having a screw boss

(75) Inventor: Gunter Ganz, Gross-Umstadt (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/519,673

(22) Filed: Sep. 12, 2006

(30) Foreign Application Priority Data
Sep. 12, 2005 (DE) 10 2005 043 562.9

(51) Int. Cl. B60R 13/02

(52) U.S. Cl. 296/1.08

(57) ABSTRACT

A plastic element, which is in particular attached in the interior of a motor vehicle, has at least one screw boss formed in one piece with the plastic element in an injection molding process. The screw boss has an outer wall and a passage with an associated inner wall, a rotationally symmetrical narrowest point for fixing a screw being formed in the inner wall. The screw can be fixed in the passage in a direction which lies at an acute angle relative to the main demolding direction of the injection molding process. To ensure that the plastic element is produced without an undercut, the outer wall of the screw boss runs parallel to the main demolding direction, and the inner wall is spaced apart from the direction of the screw and from an inner axis, which runs parallel to the main demolding direction, with a spacing which is no smaller at any point of the passage than at the narrowest point.

### BACKGROUND OF THE INVENTION

1. Field of the Invention

The invention relates to a plastic element for attachment in the interior of a motor vehicle and having at least one screw boss which is formed in one piece with the plastic element, the at least one screw boss having a passage delimited by an inner wall and an outer wall which is situated opposite the inner wall, it being possible to fix a screw in the passage, the plastic element and the screw boss being produced by a shaping process, in particular by injection molding.

2. Description of the Related Art

Plastic elements such as covers, trim panels, faceplates or housing parts are currently used in the interior of motor vehicles and also in various electrical and electronic units in the consumer goods industry, for example in white or brown goods, or in units in the field of communication technology. Here, the plastic elements are fastened by screws, clips or latching hooks, for which purpose corresponding recesses are provided, and fastening devices are integrally formed on the plastic elements.

DE 43 13 147 A1, for example, discloses an instrument cluster for a motor vehicle having a front frame, and plastic screw-on columns which are integrally formed on the rear side of the front frame and serve as fastening devices. Threaded stems plug into the screw-on columns, it being possible to place screw caps having an internal threaded bore onto said threaded stems in order to thus fasten a cover to the front frame.

Plastic elements are generally produced together with the associated fastening devices by shaping processes such as injection molding or compression molding. In such shaping processes, at least two tool parts are used which, when placed on top of one another, generate a cavity which forms the exact shape of the plastic element. The plastic material is injected, poured or pressed into the cavity. After the end of the shaping process, the plastic element must be released from the tool parts, for which purpose the latter are moved apart and away from the plastic element. The process of releasing the plastic element from the tool part is referred to as demolding and the direction in which the tool parts are moved is the main demolding direction. Parts of the plastic element which cannot be demolded by simply opening the tool parts and moving them apart are referred to as undercuts. Sliders or pushers are required in order to demold such parts, the sliders or pushers releasing the undercuts from the tool parts separately. The more undercuts are provided, the more complex the tool parts and therefore the more complex the production of the plastic element.

DE 102 45 255 B3 therefore proposes forming a bracket, which is provided on a plastic part, without an undercut. The bracket has a recess into which a fastening element, such as a fastening clip or a screw, can be inserted substantially transversely with respect to its plug-in direction. The bracket additionally has a holding plate with a cut-out, which is open toward the edge of the holding plate, for holding a so-called neck part of the fastening element. This arrangement is not only complicated but is also unsuitable for a screw connection since the fact that the recess is only accessible from the transverse direction would make it difficult to engage a screwdriver on the screw head. In addition, the arrangement assumes only fastening elements which are to be inserted into the bracket with their longitudinal extent parallel to the main demolding direction.

### SUMMARY OF THE INVENTION

An object of the present invention to provide a plastic element which has a screw boss and can be produced in a shaping process such as injection molding which permits a screw connection at an acute angle other than zero relative to the main demolding direction, and which can simultaneously be produced with little outlay.

The object is achieved by a plastic element for attachment in the interior of a motor vehicle which includes at least one screw boss formed as one piece with the plastic element and having a passage delimited by an inner wall. The screw boss also includes an outer wall situated opposite the inner wall. The passage threadably receives a screw. The plastic element and the screw boss are produced by a shaping or molding process, preferably an injection molding process, wherein the outer wall of the screw boss runs parallel to a main demolding direction of the injection molding process. The inner wall defines a single narrowest point of the passage which is rotationally symmetrical and has a rotational axis extending at an acute angle (α) relative to the main demolding direction. An inner axis of the passage extends parallel to the main demolding direction and passes through the narrowest point, the inner wall being spaced apart from the rotational axis and from the inner axis with a spacing which is no smaller at any point of the passage than at the narrowest point, whereby the passage is formable by the injection molding process using only two opposing tool parts.

A screw which is aligned in the direction of the rotational axis can be fixed in the rotationally symmetrical narrowest point of the passage. Accordingly, the screw direction need not correspond to the main demolding direction but can be at an acute angle relative thereto. This widens the options for the design of plastic elements. The plastic elements can be better matched to uneven geometries, that is to say can also, for example, be easily fastened to curved surfaces. In the case of relatively large plastic elements, a plurality of screw bosses are provided instead of only one screw boss to allow the plastic element to be fastened using a plurality of screws. In the screw boss according to the invention, the inner wall, starting from the narrowest point, always runs at least parallel to both the main demolding direction and the screw direction. An outwardly-opening passage is generated in any case as a result of said two directions being at an acute angle relative to one another. This always ensures that the screw boss can be produced without an undercut. The tool parts for the shaping process are therefore kept simple.

The narrowest point may be situated either directly at one end of the passage or in the interior thereof. When said narrowest point is arranged at one end, then the passage opens toward the other end, equating or approximating in the simplest case to a straight or inclined truncated circular cone. If the narrowest point is situated in the interior of the passage, the inner wall thereof opens toward both ends, for example in the form of two truncated circular cones placed one upon the other at their small ends. The arrangement of the narrowest point in the interior of the passage has the advantage that said narrowest point is situated at a certain distance from the screw head, resulting in the screw being better stabilized and fixed.

The diameter of the narrowest point is preferably selected such that a self-tapping screw can be screwed or threaded into the narrowest point while removing material. Here, a restricted region of the passage, said restricted region being situated behind the narrowest point starting from the screw boss, is preferably selected to be so narrow that a self-tapping screw takes hold in the inner wall of the region. This embodiment simplifies production since no further working steps for forming an inner thread are required.

To match the shape of the passage to the shape of the screw or to other factors, it is proposed in one refinement that the inner wall is, at least in sections, in the shape of a truncated circular cone. It is possible to produce any desired shape of passage by arranging different truncated circular cones having different lateral surface gradients in line. As an alternative to truncated circular cones having finite lateral surface gradient, in a further embodiment, steps are provided in sections, that is to say the spacing between the inner wall and the main demolding direction, and between the inner wall and the rotational axis, increases in a stepped fashion.

Since material accumulations form in the screw boss as a result of the main demolding direction and the screw direction being arranged at an angle to one another, a further embodiment of the present invention includes a cavity delimited by a cavity inner wall and formed in the region of the material accumulation between the outer wall and the passage of the screw boss. The cavity has an opening toward one side of the screw boss, it being possible for a cavity axis, which runs parallel to the main demolding direction, to pass through that point which is furthest remote from the opening. The cavity inner wall being space apart from said cavity axis with a spacing which is no smaller anywhere than at the furthest remote point. It is thus also ensured that the cavity can be produced without an undercut, and therefore does not adversely affect the simple production.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a sectional view of a plastic element having a screw boss and a passage which opens to one side;

FIG. 2 is a sectional view of another embodiment of a plastic element having a screw boss and a passage which opens to two sides;

FIG. 3 is a sectional view of a further embodiment of a plastic element having a screw boss and a reduced material accumulation;

FIG. 4 is a sectional view of the plastic element of FIG. 3 with the associated tool parts used for making the plastic part;

FIGS. 5a, 5b are sectional views of the plastic element of FIG. 3 with a screw inserted in the screw boss.

### DETAILED DESCRIPTION OF THE PRESENTLY PREFERRED EMBODIMENTS

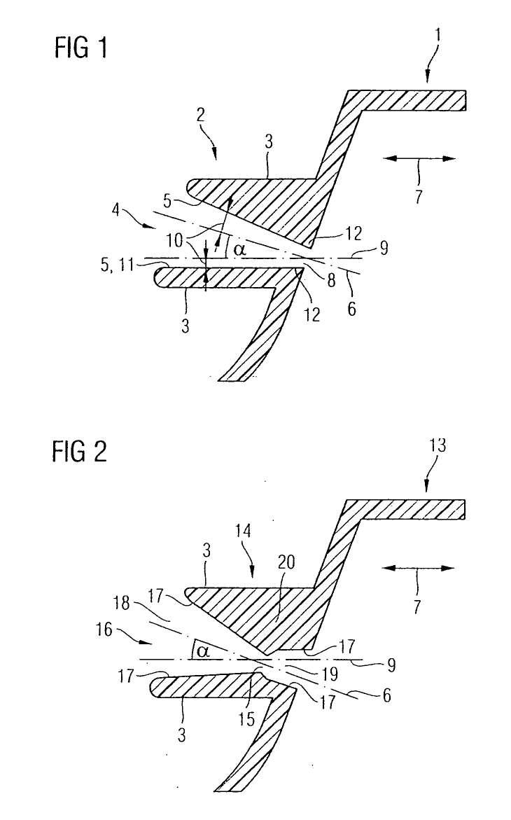

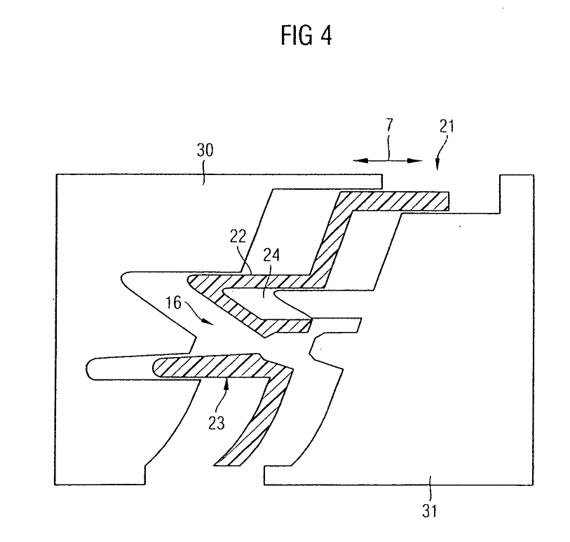

FIG. 1 shows a plastic element 1 having a screw boss 2 integrally formed into the plastic element 1. The plastic element 1 serves to cover an On-Board Diagnostic (OBD) socket which is arranged in the interior of a motor vehicle, that is to say to cover an on-board diagnostic connection. The screw boss 2 has a passage 4 delimited by an inner wall 5. An outer wall 3 of the screw boss 2 is situated opposite the inner wall 5. The double arrow indicates the main demolding direction 7 which applies during the production of the plastic element 1 in an injection molding process. Here, two tool parts, which are placed on top of one another and delimit the plastic element at the left and at the right (cf. FIG. 4), are moved apart in the main demolding direction 7 after the end of the injection molding process. The outer wall 3 runs parallel to the main demolding direction 7.

A screw (not illustrated in FIG. 1) can be fixed in the passage 4 in a screw direction which runs in an oblique fashion relative to the main demolding direction 7. For this purpose, the passage 4 has a single narrowest point 8 which is rotationally symmetrical. The rotational axis 6 of the point 8 corresponds to the screw direction and runs at an acute angle a relative to the main demolding direction 7. An inner axis 9, which runs parallel to the main demolding direction 7, is located in the narrowest point 8. The level of the inner axis 9 within the narrowest point 8 can be selected arbitrarily. In order to permit shaping without an undercut, the inner wall 5 is spaced apart from the rotational axis 6 and from the inner axis 9 with a spacing 10 which is always at least the same as or greater than at the narrowest point 8. Overall, the passage 4 is in the shape of an inclined truncated cone, with the casing side 11 which slopes to a lesser degree running parallel to the main demolding direction 7. The diameter of the narrowest point 8 is selected such that a self-tapping screw can cut into the surrounding material 12.

FIG. 2 shows a plastic element 13 having a screw boss 14 whose narrowest point 15 is situated in the interior of the passage 16. The rotational axis 6 of the narrowest point 15 corresponds to the same direction as in FIG. 1. The main demolding direction 7 and accordingly the profile of the inner axis 9 likewise remain unchanged. Starting from the narrowest point 15, the inner wall 17 is spaced apart from the rotational axis 6 and from the inner axis 9 with a spacing which remains constant or increases toward the ends of the passage. Here, the region 18 of the passage to the left of the narrowest point 15 in FIG. 2 is embodied as an inclined truncated cone, and the region 19 of the passage to the right of the narrowest point 15 is composed of two truncated cones having different lateral surface gradients.

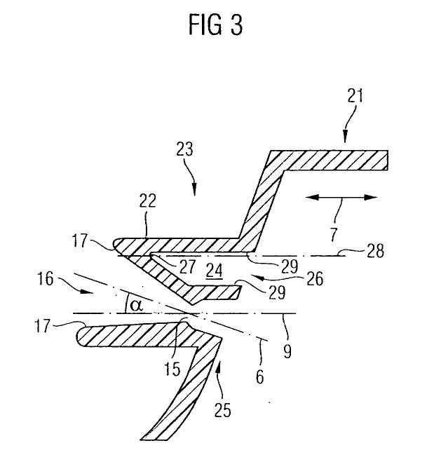

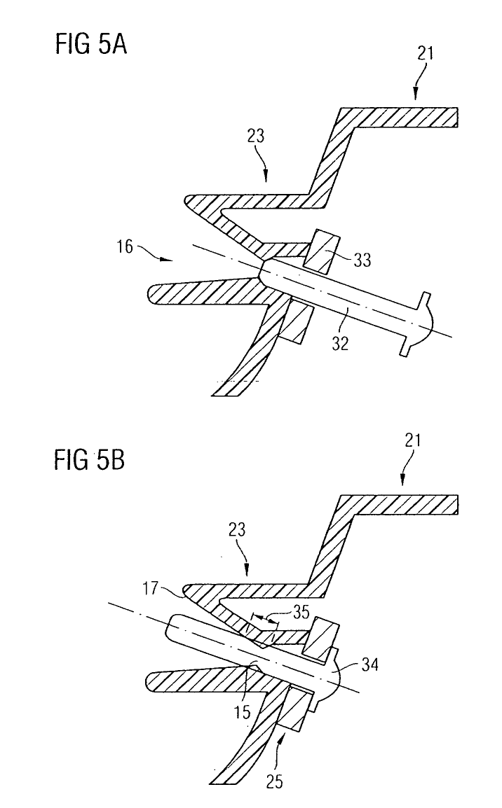

As can be gathered from FIG. 2, a material accumulation 20 is generated on the screw boss 14. To reduce said material accumulation, FIG. 3 shows a cavity 24 interposed between the outer wall 22 of the screw boss 23 and the passage 16, the cavity 24 having an opening 26 toward one side 25 of the screw boss 23. The screw which is to be fixed into the passage 16 is inserted starting from the side 25, that is to say the screw head will be situated on the side 25 of the screw boss 23 (cf. FIG. 5b). A cavity axis 28, which runs parallel to the main demolding direction 7, passes through a point 27 in the interior of the cavity 24 which is furthest remote from the opening 26. The inner wall 29 is spaced apart from the cavity axis 28 with a spacing which is no smaller anywhere than at the point 27 which is furthest remote from the opening 26.

FIG. 4 illustrates two tool parts 30 and 31 which are joined together before the injection molding operation. The plastic material is sprayed into the cavity generated between the two tool parts 30 and 31, thus forming the plastic element 21. After the plastic has hardened, the tool parts 30 and 31 are moved away from the plastic element 21 in opposite directions along the main demolding direction 7, so that said plastic element 21 is released. The movement alone is sufficient to release the plastic element 21 from the tool parts 30 and 31. As a result of the specific alignment of the outer wall 22 of the screw boss 23, and as a result of the design of the passage 16 and of the cavity 24, no undercut which must be separated from the tool parts 30 and 31 by an additional slider is present.

According to FIGS. 5a and 5b, a screw 32 is screwed into the screw boss 23 of the plastic element 21 to thus fasten the plastic element 21 to a bracket 33. The screw 32 is a self-tapping screw which cuts into the narrowest point 15 and into a region 35 of the inner wall 17, the region 35 being situated behind the narrowest point 15 starting from the screw head 34. The screw 32 is therefore fixed by the bracket 33 and by the narrowest point 15.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A plastic element for attachment in the interior of a motor vehicle, comprising a screw boss formed as one piece with said plastic element by a molding process and defining a passage arranged and dimensioned for threadably receiving a screw and delimited by an inner wall, said screw boss further comprising an outer wall situated opposite said inner wall, arranged and dimensioned for threadably receiving a screw, said outer wall of said screw boss running parallel to a main demolding direction of the molding process, said inner wall defining a single narrowest point of said passage which is rotationally symmetrical and has a rotational axis extending at an acute angle (α) relative to the main demolding direction, said passage having an inner axis and extending parallel to the main demolding direction and passing through said narrowest point, said inner wall being spaced apart from said rotational axis and from said inner axis with a spacing which is no smaller at any point of said passage than at said narrowest point, whereby said passage is formable by the molding process using only two opposing tool parts.

2. The plastic element of claim 1, wherein said narrowest point is arranged directly at one end of said passage.

3. The plastic element of claim 1, wherein said narrowest point is arranged in an interior of said passage.

4. The plastic element of claim 1, wherein a diameter of said narrowest point is arranged and dimensioned such that a self-tapping screw is threadably receivable into said narrowest point while removing material.

5. The plastic element of claim 4, wherein said screw boss defines a restricted region of said passage, said restricted region is situated behind said narrowest point relative to a first side of said passage and is dimensioned such that the self-tapping screw receivable in said passage also holds the inner wall in said restricted region.

6. The plastic element of claim 1, wherein said inner wall has a truncated cone shape in at least a section of said passage outside said narrowest point.

7. The plastic element of claim 6, wherein an entire section of said passage between said narrowest point and an opposite end of said passage has a truncated circular cone shape.

8. The plastic element of claim 1, wherein a spacing between said inner wall and said inner axis increases in a stepped fashion at least in sections.

9. The plastic element of claim 1, wherein said screw boss defines a cavity delimited by a cavity inner wall formed between said outer wall and said passage of said screw boss, said cavity having an opening toward one side of said at least one screw boss, a cavity axis parallel to the main demolding direction passes through a point in the interior of the cavity which is furthest remote from the opening, and said cavity inner wall being spaced apart from said cavity axis with a spacing which is no smaller anywhere than at the furthest remote point, whereby said cavity is formable by the molding process using only two opposing tool parts.

10. The plastic element of claim 1, wherein the molding process is an injection molding process.
